(19) United States
(12) Patent Application Publication
(10) Pub. No.: US 2020/0089172 A1
(43) Pub. Date: Mar. 19, 2020

(54) ELECTRONIC APPARATUS AND OPERATION METHOD THEREOF

(71) Applicant: LG Electronics Inc., Seoul (KR)

(72) Inventors: Sungho YOON, Seoul (KR); Sangwook LEE, Seoul (KR)

(21) Appl. No.: 16/692,498

(22) Filed: Nov. 22, 2019

(30) Foreign Application Priority Data
Oct. 25, 2019 (KR) 10-2019-0133579

(51) Int. Cl. G05B 13/02; G05D 1/00

(52) U.S. Cl. CPC G05B 13/027; G05D 1/0088

(57) ABSTRACT

Provided is a method of predicting an intrusion to occur in a network of a vehicle based on information on the vehicle and an electronic apparatus therefor. In the present disclosure, at least one of an electronic apparatus, a vehicle, a vehicle terminal, and an autonomous vehicle may be connected with an artificial intelligence (AI) module, an unmanned aerial vehicle (UAV), a robot, an augmented reality (AR) device, a virtual reality (VR) device, and a device related to a 5G service, for example.

### CROSS-REFERENCE TO RELATED APPLICATION

This application claims the benefit of Korean Patent Application No. 10-2019-0133579, filed on Oct. 25, 2019, in the Korean Intellectual Property Office, the disclosure of which is incorporated herein in its entirety by reference.

### BACKGROUND

### 1. Field

This disclosure relates to a method of predicting an intrusion to occur in a network of a vehicle and an electronic apparatus therefor.

### 2. Description of the Related Art

As electronic control units (ECUs) mounted in a vehicle increase, the vehicle may use an in-vehicle network such as a controller area network (CAN) and a local interconnect network (LIN) for efficient communication between the ECUs. For the vehicle to stably use the in-vehicle network, there is a desire for a method to more effectively detect an intrusion occurring in the in-vehicle network.

An autonomous vehicle refers to a vehicle equipped with an autonomous driving device that recognizes an environment around the vehicle and a state of the vehicle to control driving of the vehicle based on the environment and the state. With progress in research on autonomous vehicles, studies on various services that may increase a user's convenience using the autonomous vehicle are also in progress.

### SUMMARY

An aspect provides an electronic apparatus and an operation method thereof. Technical goals to be achieved through the example embodiments are not limited to the technical goals as described above, and other technical tasks can be inferred from the following example embodiments.

According to an aspect, there is provided an operation method of an electronic apparatus, the method including receiving information on a vehicle from the vehicle, determining a type of an intrusion to occur in a network of the vehicle based on the information on the vehicle, and transmitting information on the determined type to the vehicle.

According to another aspect, there is also provided an electronic apparatus including a communicator, and a controller configured to receive information on a vehicle from the vehicle through the communicator, determine a type of an intrusion to occur in a network of the vehicle based on the information on the vehicle, and transmit information on the determined type to the vehicle.

According to another aspect, there is also provided a terminal of a vehicle, the terminal including a communicator, and a controller configured to transmit information on the vehicle to an external device through the communicator, receive information on a type of an intrusion to occur in a network of the vehicle from the external device through the communicator, and determine whether an intrusion occurs in the network of the vehicle using an intrusion detecting method suitable for detecting an intrusion having the type.

According to another aspect, there is also provided a non-transitory computer-readable storage medium including a non-volatile storage medium including programs to execute the above-described method on a computer.

Specific details of example embodiments are included in the detailed description and drawings.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 is a block diagram illustrating a wireless communication system to which the methods proposed in the present disclosure are applicable;

FIG. 5 is a diagram illustrating an example of a signal transmission and reception method performed in a wireless communication system;

FIG. 6 illustrates an example of basic operations of an autonomous vehicle and a 5G network in a 5G communication system;

FIG. 7 illustrates an example of basic operations between a vehicle and another vehicle using 5G communication;

FIG. 8 is a flowchart illustrating operations of an electronic apparatus and a vehicle;

FIG. 9 illustrates priorities of intrusion detecting methods based on an intrusion type according to an example embodiment;

FIG. 10 illustrates a detection intensity of an intrusion detecting method changed based on a priority of the intrusion detecting method according to an example embodiment;

FIG. 11 illustrates an electronic apparatus determining a type of an intrusion to occur in a network of a vehicle according to an example embodiment;

FIG. 12 is a block diagram illustrating an electronic apparatus;

FIG. 13 is a block diagram illustrating a terminal of a vehicle; and

FIG. 14 is a flowchart illustrating an operation method of an electronic apparatus.

### DETAILED DESCRIPTION

The terms used in the embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

In addition, in this specification, “artificial intelligence (AI)” refers to the field of studying artificial intelligence or a methodology capable of making the artificial intelligence, and “machine learning” refers to the field of studying methodologies that define and solve various problems handled in the field of artificial intelligence. The machine learning is also defined as an algorithm that enhances performance for a certain operation through a steady experience with respect to the operation.

An “artificial neural network (ANN)” may refer to a general model for use in the machine learning, which is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output the value of an activation function concerning signals input through the synapse, weights, and deflection thereof.

The model parameters refer to parameters determined by learning, and include weights for synaptic connection and deflection of neurons, for example. Then, hyper-parameters refer to parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

The machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by the artificial neural network when learning data is input to the artificial neural network. The unsupervised learning may refer to a learning method for the artificial neural network in the state in which no label for learning data is given. The reinforcement learning may refer to a learning method in which an agent defined in a certain environment learns to select a behavior or a behavior sequence that maximizes cumulative compensation in each state.

The machine learning realized by a deep neural network (DNN) including multiple hidden layers among artificial neural networks is also called deep learning, and the deep learning is a part of the machine learning. In the following description, the machine learning is used as a meaning including the deep learning.

In addition, in this specification, a vehicle may be an autonomous vehicle. “Autonomous driving” refers to a self-driving technology, and an “autonomous vehicle” refers to a vehicle that performs driving without a user's operation or with a user's minimum operation. In addition, the autonomous vehicle may refer to a robot having an autonomous driving function.

For example, autonomous driving may include all of a technology of maintaining the lane in which a vehicle is driving, a technology of automatically adjusting a vehicle speed such as adaptive cruise control, a technology of causing a vehicle to automatically drive in a given route, and a technology of automatically setting a route, along which a vehicle drives, when a destination is set.

Here, a vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described with reference to the drawings.

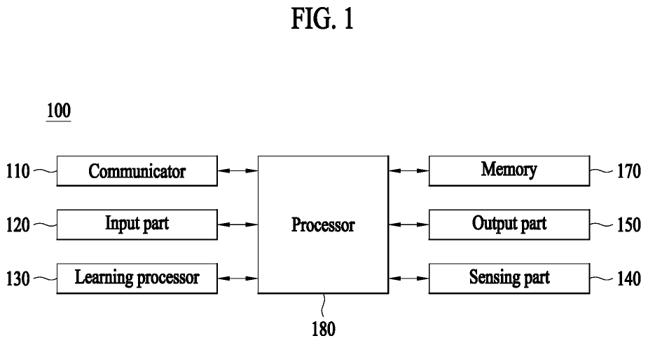

FIG. 1 illustrates an AI device according to an example embodiment.

The AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, a vehicle, or an X reality (XR) device.

Referring to FIG. 1, the AI device 100 may include a communicator 110, an input part 120, a learning processor 130, a sensing part 140, an output part 150, a memory 170, and a processor 180. However, not all components shown in FIG. 1 are essential components of the AI device 100. The AI device may be implemented by more components than those illustrated in FIG. 1, or the AI device may be implemented by fewer components than those illustrated in FIG. 1.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

At this time, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

The input part 120 may acquire various types of data.

At this time, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, the learning processor 130 may perform AI processing along with a learning processor 240 of the AI server 200.

At this time, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100, environmental information around the AI device 100, and user information using various sensors.

At this time, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, a radar, and a temperature sensor, for example.

The output part 150 may generate, for example, a visual output, an auditory output, or a tactile output.

At this time, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example. The memory 170 may include a storage medium of at least one type among a flash memory, a hard disk, a multimedia card micro type memory, a card type memory (e.g., SD or XD memory), a random access memory (RAM) a static random access memory (SRAM), a read only memory (ROM), an electrically erasable programmable read-only memory (EEPROM), a programmable read-only memory (PROM), a magnetic memory, a magnetic disc, and an optical disc.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

At this time, when connection of an external device is required to perform the determined operation, the processor 180 may generate a control signal for controlling the external device and may transmit the generated control signal to the external device.

The processor 180 may acquire intention information with respect to user input and may determine a user request based on the acquired intention information.

At this time, the processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by the learning processor 130, may have learned by a learning processor 240 of the AI server 200, or may have learned by distributed processing of these processors.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the AI device 100 in order to drive an application program stored in the memory 170. Moreover, the processor 180 may combine and operate two or more of the constituent elements of the AI device 100 for the driving of the application program.

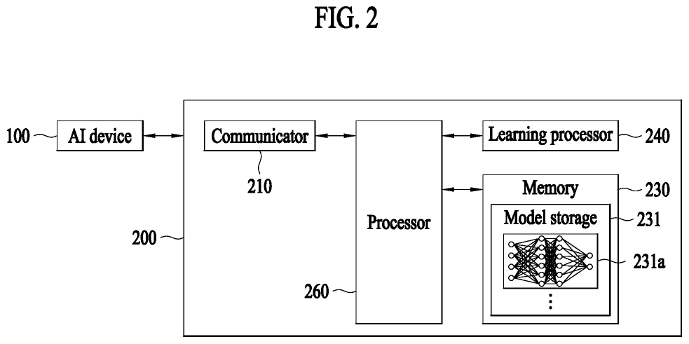

FIG. 2 illustrates an AI server according to an example embodiment.

Referring to FIG. 2, an AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. At this time, the AI server 200 may be included as a constituent element of the AI device 100 so as to perform at least a part of AI processing together with the AI device.

The AI server 200 may include a communicator 210, a memory 230, a learning processor 240, and a processor 260.

The communicator 210 may transmit and receive data to and from an external device such as the AI device 100.

The memory 230 may include a model storage 231. The model storage 231 may store a model (or an artificial neural network 231a) which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

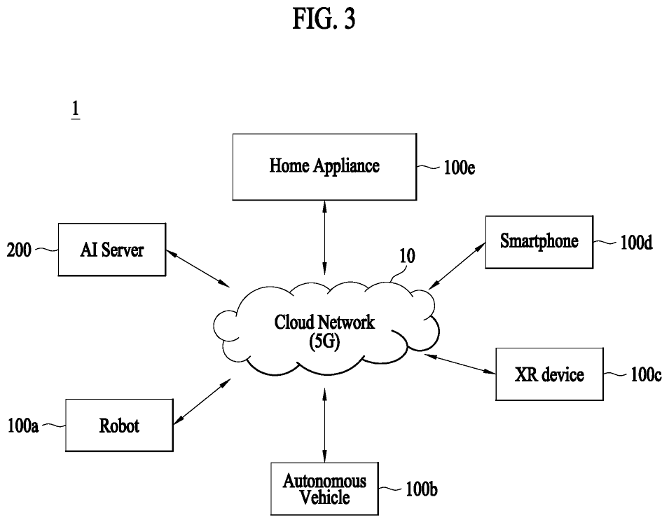

FIG. 3 illustrates an AI system according to an example embodiment.

Referring to FIG. 3, in the AI system 1, at least one of the AI server 200, a robot 100a, an autonomous vehicle 100b, an XR device 100c, a smart phone 100d, and a home appliance 100e is connected to a cloud network 10. Here, the robot 100a, the autonomous vehicle 100b, the XR device 100c, the smart phone 100d, and the home appliance 100e, to which AI technologies are applied, may be referred to as AI devices 100a to 100e.

The cloud network 10 may constitute a part of a cloud computing infrastructure, or may refer to a network present in the cloud computing infrastructure. Here, the cloud network 10 may be configured using a 3G network, a 4G or long term evolution (LTE) network, or a 5G network, for example.

That is, respective devices 100a to 100e and 200 constituting the AI system 1 may be connected to each other via the cloud network 10. In particular, respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smart phone 100d, and the home appliance 100e, which are AI devices constituting the AI system 1, via cloud network 10, and may assist at least a part of AI processing of connected the AI devices 100a to 100e.

At this time, instead of the AI devices 100a to 100e, the AI server 200 may cause an artificial neural network to learn according to a machine learning algorithm, and may directly store a learning model or may transmit the learning model to the AI devices 100a to 100e.

At this time, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various example embodiments of the AI devices 100a to 100e, to which the above-described technology is applied, will be described. Here, the AI devices 100a to 100e illustrated in FIG. 3 may be specific example embodiments of the AI device 100 illustrated in FIG. 1.

The autonomous vehicle 100b may be realized into a mobile robot, a vehicle, or an unmanned air vehicle, for example, through the application of AI technologies.

The autonomous vehicle 100b may include an autonomous driving control module for controlling an autonomous driving function, and the autonomous driving control module may mean a software module or a chip realized in hardware. The autonomous driving control module may be a constituent element included in the autonomous vehicle 1200b, but may be a separate hardware element outside the autonomous vehicle 1200b so as to be connected thereto.

The autonomous vehicle 100b may acquire information on the state of the autonomous vehicle 1200b using sensor information acquired from various types of sensors, may detect or recognize the surrounding environment and an object, may generate map data, may determine a movement route and a driving plan, or may determine an operation.

Here, the autonomous vehicle 100b may use sensor information acquired from at least one sensor among a lidar, a radar, and a camera in the same manner as the robot 1200a in order to determine a movement route and a driving plan.

In particular, the autonomous vehicle 100b may recognize the environment or an object with respect to an area outside the field of vision or an area located at a predetermined distance or more by receiving sensor information from external devices, or may directly receive recognized information from external devices.

The autonomous vehicle 100b may perform the above-described operations using a learning model configured with at least one artificial neural network. For example, the autonomous vehicle 100b may recognize the surrounding environment and the object using the learning model, and may determine a driving line using the recognized surrounding environment information or object information. Here, the learning model may be directly learned in the autonomous vehicle 100b, or may be learned in an external device such as the AI server 200.

At this time, the autonomous vehicle 100b may generate a result using the learning model to perform an operation, but may transmit sensor information to an external device such as the AI server 200 and receive a result generated by the external device to perform an operation.

The autonomous vehicle 100b may determine a movement route and a driving plan using at least one of map data, object information detected from sensor information, and object information acquired from an external device, and a drive part may be controlled to drive the autonomous vehicle 100b according to the determined movement route and driving plan.

The map data may include object identification information for various objects arranged in a space (e.g., a road) along which the autonomous vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, the autonomous vehicle 100b may perform an operation or may drive by controlling the drive part based on user control or interaction. At this time, the autonomous vehicle 100b may acquire interactional intention information depending on a user operation or voice expression, and may determine a response based on the acquired intention information to perform an operation.

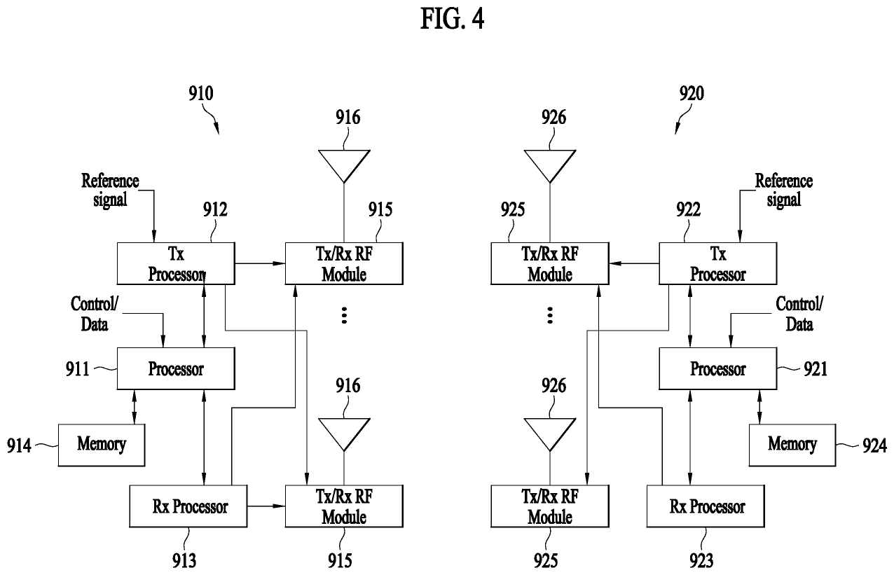

FIG. 4 is a block diagram illustrating a wireless communication system to which the methods proposed in the present disclosure are applicable.

Referring to FIG. 4, a device including an autonomous vehicle, hereinafter also referred to as “autonomous driving device”, may be defined as a first communication device as indicated by a reference numeral 910. A processor 911 may perform a detailed operation for autonomous driving.

A 5G network including another vehicle that communicates with the autonomous driving device may be defined as a second communication device, as indicated by a reference numeral 920. A processor 921 may perform a detailed operation for autonomous driving.

The 5G network may also be referred to as the first communication device and the autonomous driving device may also be referred to as the second communication device.

The first communication device or the second communication device may be, for example, a base station, a network node, a transmitting terminal, a receiving terminal, a wireless device, a wireless communication device, and an autonomous driving device.

A terminal or user equipment (UE) may include, for example, a vehicle, a mobile phone, a smartphone, a laptop computer, a digital broadcast terminals, a personal digital assistant (PDA), a portable multimedia player (PMP), a navigator, a slate PC, a tablet PC, an ultrabook, and a wearable device such as a smartwatch, a smart glass, and a head mounted display (HMD), and the like. For example, the HMD may be a display device to be worn on a head. For example, the HMD may be used to implement a virtual reality (VR), an augmented reality (AR), or a mixed reality (MR). Referring to FIG. 4, the first communication device 910 and the second communication device 920 may include the processors 911 and 921, the memory 914 and 924, one or more Tx/Rx radio frequency (RF) modules 915 and 925, Tx processors 912 and 922, Rx processors 913 and 923, and antennas 916 and 926. The Tx/Rx module may also be referred to as a transceiver. Each of the Tx/Rx RF modules 915 and 925 may transmit a signal using the antennas 916 and 926. The processor may implement the functions, processes, and/or methods described herein. The processor 921 may be associated with the memory 924 that stores a program code and data. The memory may also be referred to as a computer-readable medium. Specifically, in downlink (DL) communication, for example, communication from the first communication device to the second communication device, the Tx processor 912 may implement various signal processing functions for a layer L1, that is, a physical layer. The Rx processor may implement various signal processing functions of the layer L1, that is, a physical layer.

Uplink (UL) communication, for example, communication from the second communication device to the first communication device may be processed in the first communication device 910 in a manner similar to that described with respect to the function of the receiver in the second communication device 920. Each of the Tx/Rx modules 925 may receive a signal using the antenna 926. Each of the Tx/Rx modules may provide a radio frequency (RF) carrier wave and information to the Rx processor 923. The processor 921 may be associated with the memory 924 that stores a program code and data. The memory may also be referred to as a computer-readable medium.

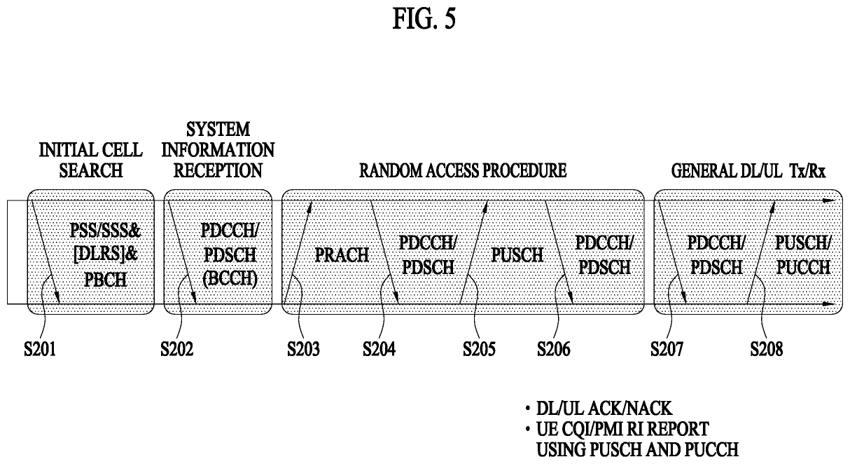

FIG. 5 illustrates an example of a signal transmission and reception method performed in a wireless communication system.

Referring to FIG. 5, in operation S201, when UE is powered on or enters a new cell, the UE performs an initial cell search procedure such as acquisition of synchronization with a BS. To this end, the UE may adjust synchronization with the BS by receiving a primary synchronization channel (P-SCH) and a secondary synchronization channel (S-SCH) from the BS and acquire information such as a cell identifier (ID). In an LTE system and a new radio (NR) system, the P-SCH and the S-SCH may also be referred to as a primary synchronization signal (PSS) and a secondary synchronization signal (SSS), respectively. After the initial cell search, the UE may acquire in-cell broadcast information by receiving a physical broadcast channel from the BS. In the initial cell search procedure, the UE may monitor a DL channel state by receiving a downlink reference signal (DL RS). When the initial cell search procedure is terminated, in operation S202, the UE may acquire more detailed system information by receiving a physical downlink control channel (PDCCH) and a physical downlink shared channel (PDSCH) based on information carried on the PDCCH.

Meanwhile, if the UE initially accesses the BS or if radio resources for signal transmission are absent, the UE may perform a random access procedure with respect to the BS in operations S203 through S206. To this end, the UE may transmit a specific sequence as a preamble through a physical random access channel (PRACH) in operations S203 and S205 and receive a random access response (RAR) message for the preamble through the PDCCH and the PDSCH corresponding to the PDCCH in operations S204 and S206. In the case of a contention-based RACH, the UE may additionally perform a contention resolution procedure.

After performing the above procedures, the UE may perform PDCCH/PDSCH reception in operation S207 and perform physical uplink shared channel (PUSCH)/physical uplink control channel (PUCCH) transmission in operation S208, as a general UL/DL signal transmission procedure. For example, the UE may receive downlink control information (DCI) through the PDCCH. The UE may monitor a set of PDCCH candidates in monitoring occasions set in one or more control element sets (CORESETs) on a serving cell based on corresponding search space configurations. The set of PDCCH candidates to be monitored by the UE may be defined in terms of search space sets. The search space set may be a common search space set or a UE-specific search space set. The CORESET may include a set of (physical) resource blocks having a time duration of one to three orthogonal frequency division multiplexing (OFDM) symbols. A network may set the UE to have a plurality of CORESETs. The UE may monitor PDCCH candidates in one or more search space sets. Here, the monitoring may indicate attempting to decode the PDCCH candidate(s) in the search space. When the UE succeeds in decoding one of the PDCCH candidates in the search space, the UE may determine that the PDCCH is detected in the corresponding PDCCH candidate and perform PDSCH reception or PUSCH transmission based on the DCI in the detected PDCCH. The PDCCH may be used to schedule DL transmission on the PDSCH and UL transmission on the PUSCH. Here, the DCI on the PDCCH may include downlink assignment, that is, a downlink grant (DL grant) including at least a modulation and coding format and resource allocation information in association with a downlink shared channel, or an uplink grant (UL grant) including a modulation and coding format and resource allocation information in association with an uplink shared channel.

An initial access (IA) procedure performed in a 5G communication system will be further described with reference to FIG. 5.

UE may perform cell search, system information acquisition, beam alignment for initial access, DL measurement, and the like based on a synchronization signal block (SSB). The term “SSB” may be interchangeably used with the term “synchronization signal/physical broadcast channel (SS/PBCH) block”.

The SSB may include a PSS, an SSS, and a PBCH. The SSB may include four consecutive OFDM symbols. For each of the OFDM symbols, the PSS, the PBCH, the SSS/PBCH, or the PBCH may be transmitted. The PSS and the SSS may each include one OFDM symbols and 127 subcarriers. The PBCH may include three OFDM symbols and 576 subcarriers.

The cell search may indicate a process in which the UE acquires time/frequency synchronization of a cell and detect a cell ID, for example, a physical layer cell ID (PCI) of the cell. The PSS may be used to detect a cell ID in a cell ID group. The SSS may be used to detect the cell ID group. The PBCH may be used for SSB (time) index detection and half-frame detection.

336 cell ID groups may be present. Three cell IDs may belong to each of the cell ID groups. Information on a cell ID group to which a cell ID of a cell belongs may be provided/acquired through an SSS of the cell. Information on the cell ID among 336 cells in the cell ID may be provided/acquired through the PSS.

The SSB may be periodically transmitted based on an SSB periodicity. When performing the initial cell search, a basic SSB periodicity assumed by the UE may be defined as 20 ms. After the cell connection, the SSB periodicity may be set to one of 5 ms, 10 ms, 20 ms, 40 ms, 80 ms, and 160 ms by a network, for example, the BS.

Acquisition of system information (SI) will be described as follows.

The SI may be divided into a master information block (MIB) and a plurality of system information blocks (SIBs). The SI other than the MIB may be referred to as remaining minimum system information (RMSI). The MIB may include information/parameter for monitoring the PDCCH that schedules the PDSCH carrying SystemInformationBlock1 (SIB1), and may be transmitted by the BS through the PBCH of the SSB. The SIB1 may include information associated with availabilities and scheduling (e.g., a transmission period and an SI-window size) of remaining SIBs (hereinafter, referred to as “SIBx”, x being an integer greater than or equal to 2). The SIBx may be included in an SI message and transmitted through the PDSCH. Each SI message may be transmitted within a time window, that is, an SI-window occurring periodically.

A random access (RA) procedure performed in the 5G communication system will be further described with reference to FIG. 5.

The RA procedure may be used for various purposes. For example, the RA procedure may be used for network initial access, handover, and UE-triggered UL data transmission. The UE may acquire UL synchronization and UL transmission resources through the RA procedure. The RA procedure may include a contention-based RA procedure and a contention-free RA procedure. A detailed process of the contention-based RA procedure is described as follows.

The UE may transmit an RA preamble through the PRACH as Msg1 of the RA procedure in the UL communication. RA preamble sequences having two different lengths may be supported. A large sequence length of 839 may be applied to subcarrier spacing of 1.25 and 5 kilohertz (kHz). A small sequence length of 139 may be applied to subcarrier spacing of 15 kHz, 30 kHz, 60 kHz, and 120 kHz.

When the BS receives the RA preamble from the UE, the BS may transmit a random access response (RAR) message Msg2 to the UE. The PDCCH that schedules the PDSCH carrying the RAR may cyclic redundancy check (CRC)-masked with an RA radio network temporary identifier (RA-RNTI), and then transmitted. The UE may detect the PDCCH masked with the RA-RNTI and receive the RAR from the PDSCH scheduled by the DCI carried by the PDCCH. The UE may verify whether a preamble transmitted by the UE, that is, RAR information for the Msg1 is present in the RAR. Whether RA information for the Msg1 transmitted by the UE is present may be determined based on whether an RA preamble ID for the preamble transmitted by the UE is present. When a response to the Msg1 is absent, the UE may retransmit an RACH preamble within a predetermined number of times while performing power ramping. The UE may calculate PRACH transmitting power for retransmitting a preamble based on a most recent path loss and a power ramping counter.

The UE may perform the UL transmission on the uplink shared channel based on the RAR information as transmission of Msg3 in the random access procedure. The Msg3 may include an RRC connection request and a UE identifier. As a response to the Msg3, the network may transmit Msg4, which may be treated as a contention resolution message on the DL. By receiving the Msg4, the UE may enter an RRC-connected state.

Ultra-reliable and low latency communication (URLLC) transmission defined in the NR may be transmission associated with: (1) a relatively low traffic amount; (2) a relatively low arrival rate; (3) an ultra-low latency requirement (e.g., 0.5 and 1 ms); (4) a relatively short transmission duration (e.g., 2 OFDM symbols); and (5) an urgent service/message. In the case of the UL, to satisfy a more stringent latency requirement, transmission of a specific type of traffic, for example, URLLC may be multiplexed with another transmission scheduled in advance, for example, enhanced Mobile Broadband communication (eMBB). As one method related thereto, information indicating that preemption is to be performed on predetermined resources is transmitted to the UE scheduled in advance, so that URLLC UE uses the corresponding resources for UL transmission.

In a case of the NR, dynamic resource sharing between the eMBB and the URLLC may be supported. eMBB and URLLC services may be scheduled on non-overlapping time/frequency resources. The URLLC transmission may occur on resources scheduled with respect to ongoing eMBB traffic. eMBB UE may not know whether PDSCH transmission of the corresponding UE is partially punctured. Also, due to corrupted coded bits, the UE may not decode the PDSCH. Considering this, a preemption indication may be provided in the NR. The preemption indication may also be referred to as an interrupted transmission indication.

In association with the preemption indication, the UE may receive DownlinkPreemption IE through RRC signaling from the BS. When the UE receives the DownlinkPreemption IE, the UE may be configured with an INT-RNTI provided by a parameter int-RNTI in the DownlinkPreemption IE for monitoring of the PDCCH conveying a DCI format 2_1. The UE may be additionally configured to have a set of serving cells by INT-ConfigurationPerServing Cell including a set of serving cell indices provided by servingCellID and a corresponding set of positions for fields in the DCI format 2_1 by positionInDCI, configured to have information payload size for the DCI format 2_1 by dci-PayloadSize, and configured to have an indication granularity of time-frequency resources by timeFrequencySect.

The UE may receive the DCI format 2_1 from the BS based on the DownlinkPreemption IE.

When the UE detects the DCI format 2_1 for a serving cell in a set of serving cells, the UE may assume that no transmission to the UE is performed in symbols and PRBs indicated by the DCI format 2_1 among a set of symbols and a set of PRBs corresponding to the last monitoring period of a monitoring period to which the DCI format 2_1 belongs. For example, the UE may determine that a signal in the time-frequency resources indicated by the preemption is not the DL transmission scheduled for the UE and thus, decode data based on signals received in remaining resource areas.

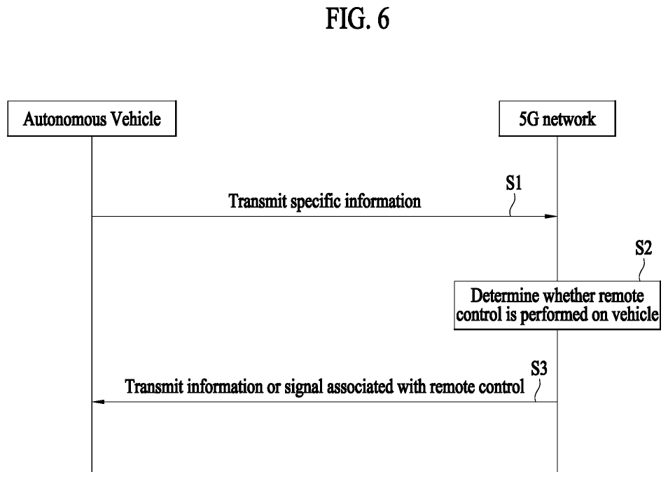

FIG. 6 illustrates an example of basic operations of an autonomous vehicle and a 5G network in a 5G communication system.

In operation S1, the autonomous vehicle may transmit specific information to a 5G network. The specific information may include autonomous driving-related information. In operation S2, the 5G network may determine whether a remote control is performed on the vehicle. Here, the 5G network may include a server or a module for performing an autonomous driving-related remote control. In operation S3, the 5G network may transmit information or a signal associated with the remote control to the autonomous vehicle.

Hereinafter, an operation of the autonomous vehicle using 5G communication will be described in detail with reference to FIGS. 4 and 5 and the aforementioned wireless communication technologies such as a beam management (BM) procedure, URLLC, massive Machine Type Communication (mMTC), and the like.

A basic procedure of an application operation to which the method proposed in the present disclosure and eMBB technology of the 5G communication are applicable will be described.

Likewise operations S1 and S3 of FIG. 6, to transmit and receive a signal, information, and the like to and from the 5G network, the autonomous vehicle may perform an initial access procedure and a random access procedure in connection with the 5G network before operation S1 of FIG. 6 is performed.

Specifically, the autonomous vehicle may perform the initial access procedure in connection with the 5G network based on an SSB to acquire a DL synchronization and system information. In the initial access procedure, a BM process and a beam failure recovery process may be added. Also, a quasi-co location (QCL) relationship may be added in a process of receiving a signal from the 5G network by the autonomous vehicle.

The autonomous vehicle may perform the random access procedure in connection with the 5G network for acquisition of a UL synchronization and/or UL transmission. The 5G network may transmit a UL grant for scheduling transmission of specific information to the autonomous vehicle. The autonomous vehicle may transmit the specific information to the 5G network based on the UL grant. In addition, the 5G network may transmit a DL grant for scheduling transmission of a result of 5G processing for the specific information to the autonomous vehicle. The 5G network may transmit information or a signal associated with the remote control to the autonomous vehicle based on the DL grant.

A basic procedure of an application operation to which URLLC technology of the 5G communication and the method proposed in the present disclosure are applicable will be described as follows.

As described above, the autonomous vehicle may perform the initial access procedure and/or the random access procedure in connection with the 5G network, and then receive DownlinkPreemption IE from the 5G network. The autonomous vehicle may receive DownlinkPreemption IE a DCI format 2_1 including a preemption indication from the 5G network. The autonomous vehicle may not perform, expect, or assume reception of eMBB data on resources, for example, a PRB and/or an OFDM symbol indicated by the preemption indication. Thereafter, when specific information is to be transmitted, the autonomous vehicle may receive the UL grant from the 5G network.

A basic procedure of an application operation to which mMTC technology of the 5G communication and the method proposed in the present disclosure are applicable will be described as follows.

Among operations of FIG. 6, a part changed according to the application of the mMTC technology will be mainly described.

Referring to FIG. 6, in operation S1, the autonomous vehicle may receive a UL grant from the 5G network to transmit specific information to the 5G network. Here, the UL grant may include information on a number of repetitions for transmission of the specific information. The specific information may be repetitively transmitted based on the information on the number of repetitions. That is, the autonomous vehicle may transmit the specific information to the 5G network based on the UL grant. The repetitive transmission of the specific information may be performed through frequency hopping. For example, first transmission of the specific information may be performed on a first frequency resource and second transmission of the specific information may be performed on a second frequency resource. The specific information may be transmitted through a narrowband of a resource block 1RB or a resource block 6RB.

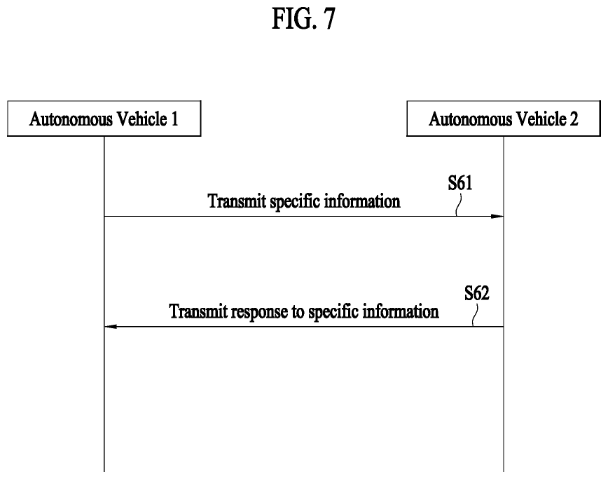

FIG. 7 illustrates an example of basic operations performed between a vehicle and another vehicle using 5G communication.

In operation S61, a first vehicle may transmit specific information to a second vehicle. In operation S62, the second vehicle may transmit a response to the specific information to the first vehicle.

A configuration of application operations between a vehicle and another vehicle may vary based on whether the 5G network is involved directly (sidelink communication transmitting mode 3) or indirectly (sidelink communication transmitting mode 4) with the specific information and resource allocation of a response to the specific information.

Application operations performed between a vehicle and another vehicle using the 5G communication will be described as follows.

First, how the 5G network is directly involved in resource allocation of signal transmission/reception between vehicles will be described.

The 5G network may transmit a DCI format 5A for scheduling of mode-3 transmission (PSCCH and/or PSSCH transmission) to the first vehicle. Here, a physical sidelink control channel (PSCCH) may be a 5G physical channel for scheduling transmission of specific information. Also, a physical sidelink shared channel (PSSCH) may be a 5G physical channel for transmitting the specific information. The first vehicle may transmit an SCI format 1 for scheduling transmission of specific information to the second vehicle on the PSCCH. Also, the first vehicle may transmit the specific information to the second vehicle on the PSSCH.

Next, how the 5G network is indirectly involved in resource allocation of signal transmission/reception between vehicles will be described.

The first vehicle may sense a resource for the mode-4 transmission in a first window. The first vehicle may select a resource for the mode-4 transmission in a second window based on a result of the sensing. Here, the first window may be a sensing window and the second window may be a selection window. The first vehicle may transmit the SCI format 1 for scheduling transmission of specific information to the second vehicle on the PSCCH based on the selected resource. Also, the first vehicle may transmit the specific information to the second vehicle on the PSSCH.

The autonomous vehicle performing at least one of V2V communication and V2X communication may transmit and receive information on a channel of the corresponding communication. For example, for the V2V communication and the V2X communication, channels for sidelinks corresponding to the communication methods may be allocated, so that the autonomous vehicle transmits and receives information on the corresponding channel to and from a server or another vehicle. Also, a shared channel for a sidelink may be allocated, so that a signal for at least one of the V2V communication and the V2X communication is transmitted and received on the corresponding channel. In order to perform at least one of the V2V communication and the V2X communication, the autonomous vehicle may acquire a separate identifier of the corresponding communication from at least one of a base station, a network, and another vehicle. The autonomous vehicle may perform the V2V communication and the V2X communication based on information on the acquired separate identifier.

Information transmitted through broadcasting may be transmitted on a separate channel for broadcasting. Node-to-node communication may be performed on a channel different from the channel for broadcasting. Also, information for controlling the autonomous vehicle may be transmitted on a channel for URLLC.

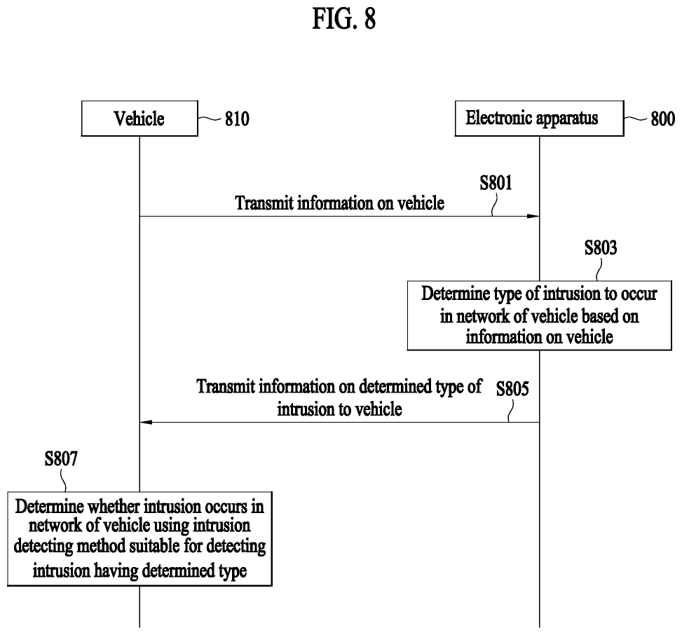

FIG. 8 is a flowchart illustrating operations of an electronic apparatus and a vehicle.

In operation S801, a vehicle 810 may transmit information on the vehicle 810 to an electronic apparatus 800. The electronic apparatus 800 may be a server. For example, the electronic apparatus 800 may be a security operation center (SOC). The information on the vehicle 810 may include information on at least one of a vehicle identification number (VIN), a type, a position, and a velocity of the vehicle 810. The information on the vehicle 810 may include information on an intrusion occurring in a network of the vehicle 810 and information on an intrusion detecting method used in the vehicle 810. The information on the vehicle 810 may include information on an electronic control unit (ECU) mounted in the vehicle 810. For example, the information on the vehicle 810 may include software version information of the ECU mounted in the vehicle 810. The vehicle 810 may periodically transmit the information on the vehicle 810 to the electronic apparatus 800.

In operation S803, the electronic apparatus 800 may determine a type of an intrusion to occur in the network of the vehicle 810 based on the information on the vehicle 810. In other words, the electronic apparatus 800 may predict a type of an intrusion that is highly probable to occur in the network of the vehicle 810 based on the information on the vehicle 810. A network of a vehicle may be a network using at least one of a controller area network (CAN), a local interconnect network (LIN), a media-oriented system transport (MOST), and FlexRay, for example. A type of an intrusion to occur in the network of the vehicle may include a malformed attack intrusion, a masquerade attack intrusion, and a fabrication attack intrusion. The malformed attack intrusion may indicate that an attacker sends an abnormal message that is not approved by design. The masquerade attack intrusion may indicate that an attacker sends a fake message after blocking a normal message. The fabrication attack intrusion may indicate that an attacker sends a fabricated message without blocking a normal message. Also, a type of an intrusion to occur in a network of a vehicle may include a bus-off attack intrusion, a flooding attack intrusion, and a drop attack intrusion. The bus-off attack intrusion may indicate forcibly generating an error to change a state of an ECU corresponding to a target to be attacked, to a bus-off state. The flooding attack intrusion may indicate generating a large amount of high-priority messages to occupy a network bandwidth. The drop attack intrusion may indicate deliberately dropping a message at a gateway during a message transfer between buses.

In one example, the electronic apparatus 800 may determine a type of an intrusion to occur in the network of the vehicle 810 based on information on a type of the vehicle 810. Specifically, based on statistics information on types of intrusions having occurred in networks of the same type of vehicles as the vehicle 810, the electronic apparatus 800 may recognize a type of intrusion frequently occurring in the same types of vehicles as the vehicle 810 and determine the recognized type of the intrusion to be a type of an intrusion to occur in the network of the vehicle 810. In another example, the electronic apparatus 800 may determine a type of an intrusion to occur in the network of the vehicle 810 based on information on an ECU mounted in the vehicle 810. Specifically, the electronic apparatus 800 may analyze software of the ECU mounted in the vehicle 810 and recognize types of intrusions having frequently occurred in networks of vehicles having the same ECU as the mounted ECU. Through this, the electronic apparatus 800 may determine the recognized type of the intrusion to be a type of an intrusion to occur in the network of the vehicle 810.

In another example, the electronic apparatus 800 may determine a type of an intrusion to occur in the network of the vehicle 810 based on information on a position of the vehicle 810. Specifically, the electronic apparatus 800 may receive information on types of intrusions detected in vehicles located within a predetermined region, from the vehicles. Through this, the electronic apparatus 800 may determine a type of an intrusion frequently occurring in the predetermined region. When the position of the vehicle 810 is in the predetermined region, the electronic apparatus 800 may determine the type of the intrusion frequently occurring in the predetermined region, to be a type of an intrusion to occur in the network of the vehicle 810. In another example, the electronic apparatus 800 may determine a type of an intrusion that is recently detected in the vehicle 810, to be a type of an intrusion to occur in the network of the vehicle 810 based on information on an intrusion history of the vehicle 810.

The electronic apparatus 800 may determine an intrusion detection method suitable for detecting an intrusion having the determined type. The electronic apparatus 800 may select an intrusion detection method suitable for detecting an intrusion having the determined type, from a plurality of intrusion detecting methods. An intrusion detecting method may include a format-based intrusion detecting method, a semantic-based intrusion detecting method, a timing-based intrusion detecting method, and a fingerprint-based intrusion detecting method. The format-based intrusion detecting method may refer to a method of determining whether a message generated in a network is a message by intrusion based on a location, a formality, or a range of a message as a feature. For example, a location of a message may be a CAN identification (ID) allowed for each CAN bus, a formality of the message may be a data length of the message, and a range of the message may be an acceptable value range of the message. The semantic-based intrusion detecting method may refer to a method of determining whether a message generated in a network is a message by intrusion based on a plausibility or a consistency of a message as a feature. The timing-based intrusion detecting method may refer to a method of determining whether a message generated in a network is a message by intrusion based on a period, a correlation, or a protocol of a message as a feature. The fingerprint-based intrusion detecting method may refer to a method of determining whether a message generated in a network is a message by intrusion based on a unique voltage characteristic of a transceiver or a unique clock characteristic of an ECU. For example, when the malformed attack intrusion is determined as a type of an intrusion to occur in the network of the vehicle 810, the electronic apparatus 800 may determine the format-based intrusion detecting method to be an intrusion detecting method suitable for detecting the malformed attack intrusion.

The electronic apparatus 800 may determine priorities of the plurality of intrusion detecting methods suitable for detecting an intrusion having the determined type. In other words, the electronic apparatus 800 may determine an order of the plurality of intrusion detecting methods to be sequentially used to detect the intrusion having the determined type. For example, when the fabrication attack intrusion is determined as a type of an intrusion to occur in the network of the vehicle 810, the electronic apparatus 800 may determine priorities of the plurality of intrusion detecting methods suitable for detecting the fabrication attack intrusion, to be an order of the timing-based intrusion detecting method, the semantic-based intrusion detecting method, the fingerprint-based intrusion detecting method, and the format-based intrusion detecting method.

In operation S805, the electronic apparatus 800 may transmit information on the determined type of the intrusion to the vehicle 810. The information on the type of the intrusion may include information on an intrusion detecting method suitable for detecting an intrusion having the corresponding type. The information on the type of the intrusion may include information on priorities of a plurality of intrusion detecting methods suitable for detecting an intrusion having the corresponding type.

In operation S807, the vehicle 810 may determine whether an intrusion occurs in the network of the vehicle 810 using the intrusion detecting method suitable for detecting the intrusion having the type determined by the electronic apparatus 800. Specifically, the vehicle 810 may determine whether a message generated in the network of the vehicle 810 is a message caused by an intrusion of an attacker, using the intrusion detecting method. For example, the vehicle 810 may determine whether a CAN message generated in the network of the vehicle 810 is a message caused by an intrusion.

In one example, the vehicle 810 may determine an intrusion detecting method suitable for detecting an intrusion having the type determined by the electronic apparatus 800 and detect an intrusion occurring in the network of the vehicle 810 using the determined intrusion detecting method. Also, the vehicle 810 may determine priorities of a plurality of intrusion detecting methods suitable for detecting an intrusion having the type determined by the electronic apparatus 800 and detect an intrusion occurring in the network of the vehicle 810 by sequentially using the plurality of intrusion detecting methods based on the determined priorities. In another example, the vehicle 810 may detect an intrusion occurring in the network of the vehicle 810 using an intrusion detecting method determined by the electronic apparatus 800. Also, the vehicle 810 may detect an intrusion occurring in the network of the vehicle 810 using a plurality of intrusion detecting methods based on priorities determined by the electronic apparatus 800.

The vehicle 810 may differently set a detection intensity for an intrusion detecting method based on a priority of the intrusion detecting method. When an intrusion detecting method has a relatively high priority, the vehicle 810 may set a high detection intensity for the intrusion detecting method. When an intrusion detecting method has a relatively low priority, the vehicle 810 may set a low detection intensity for the intrusion detecting method. A detection intensity of an intrusion detecting method may vary based on a number of characteristics for applying the intrusion detecting method, a sampling frequency of a message for applying the intrusion detecting method, and a level of a threshold. For example, to set a high detection intensity for the format-based intrusion detecting method, the vehicle 810 may implement an intrusion detecting method using a location, a formality, and a range of a message as features. To set a low detection intensity for the format-based intrusion detecting method, the vehicle 810 may implement an intrusion detecting method using a location and a range of a message. To set a high detection intensity for the timing-based intrusion detecting method, the vehicle 810 may implement an intrusion detecting method by identifying a generation time point for all the messages generated in the network of the vehicle 810. To set a low detection intensity for the timing-based intrusion detecting method, the vehicle 810 may implement an intrusion detecting method by identifying a generation frequency of a message generated in the network of the vehicle 810 for a predetermined period of time. To adjust a detection intensity of the fingerprint-based intrusion detecting method, the vehicle 810 may adjust a threshold of a voltage or a clock corresponding to a target for detection. To adjust a detection intensity of the semantic-based intrusion detecting method, the vehicle 810 may adjust a number of messages corresponding to a target for detection.

The vehicle 810 may generate a model for the fingerprint-based intrusion detecting method by collecting voltage data for each ECU mounted in the vehicle 810. Specifically, the vehicle 810 may generate a model representing a unique voltage characteristic of an ECU by collecting a message generated in each ECU mounted in the vehicle 810 and use the fingerprint-based intrusion detecting method based on the generated model. For example, the model may include information on a threshold voltage for determining whether a generated message is a message generated by a predetermined ECU. Also, the vehicle 810 may train the model representing the unique voltage characteristic of an ECU through a machine learning based on the message generated in each ECU mounted in the vehicle 810. When a predetermined event occurs, the vehicle 810 may update the model for the fingerprint-based intrusion detecting method by recollecting a message generated in each ECU mounted in the vehicle 810. For example, when an ECU mounted in the vehicle 810 is replaced, when a fingerprint-based intrusion detecting performance is degraded, or when a voltage device in the vehicle 810 is aged, the vehicle 810 may update the model for the fingerprint-based intrusion detecting method by recollecting voltage data of the ECU mounted in the vehicle 810.

The order of the operations disclosed in FIG. 8 is merely an example, and the present disclosure is not limited thereto. Each operation may be performed by the electronic apparatus 800 or the vehicle 810 in any order or simultaneously.

Since the electronic apparatus 800 may predict a type of an intrusion highly probable to occur in the network of the vehicle 810 and the vehicle 810 may employ an intrusion detecting method suitable for detecting an intrusion having the predicted type, the intrusion detecting method may be implemented with increased efficiency. Also, instead of using all of a plurality of intrusion detecting methods in parallel, the vehicle 810 may sequentially use the plurality of intrusion detecting methods to detect an intrusion having the predicted type, which may increase an efficiency of implementing the intrusion detecting method. For example, the vehicle 810 may employ an intrusion detecting method having a highest intrusion detection probability and corresponding to a first priority, thereby reducing a workload when performing the intrusion detecting method. Also, the vehicle 810 may differently set a detection intensity for an intrusion detecting method based on a priority of the intrusion detecting method, thereby implementing a more effective intrusion detecting method. For example, the vehicle 810 may set a high detection intensity for an intrusion detecting method having a highest intrusion detection probability and corresponding to a first priority, thereby more efficiently performing intrusion detection.

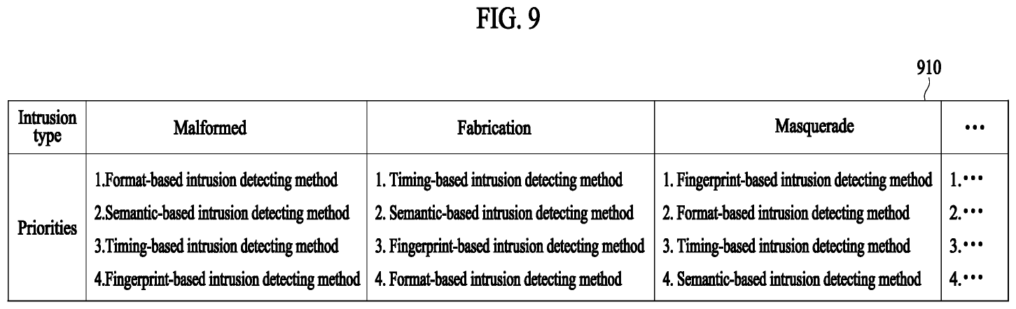

FIG. 9 illustrates priorities of intrusion detecting methods based on an intrusion type according to an example embodiment.

The electronic apparatus 800 may determine priorities of intrusion detecting methods based on an intrusion type and store information on the determined priorities. For example, the electronic apparatus 800 may store information on the priorities of the intrusion detecting methods as shown in a table 910 of FIG. 9.

Specifically, the electronic apparatus 800 may determine priorities of a plurality of intrusion detecting methods suitable for detecting a malformed attack intrusion to be an order of a format-based intrusion detecting method, a semantic-based intrusion detecting method, a timing-based intrusion detecting method, and a fingerprint-based intrusion detecting method. In other words, the electronic apparatus 800 may set the format-based intrusion detecting method suitable for detecting the malformed attack intrusion among the plurality of intrusion detecting methods, to be a first priority. Likewise, the electronic apparatus 800 may determine priorities of a plurality of intrusion detecting methods suitable for detecting a fabrication attack intrusion to be an order of the timing-based intrusion detecting method, the semantic-based intrusion detecting method, the fingerprint-based intrusion detecting method, and the format-based intrusion detecting method. Also, the electronic apparatus 800 may determine priorities of a plurality of intrusion detecting methods suitable for detecting a masquerade attack intrusion to be an order of the fingerprint-based intrusion detecting method, the format-based intrusion detecting method, the timing-based intrusion detecting method, and the semantic-based intrusion detecting method.

In another example, the vehicle 810 may determine priorities of intrusion detecting methods based on an intrusion type and store information on the determined priorities. For example, the vehicle 810 may store information on the priorities of the intrusion detecting methods as shown in the table 910 of FIG. 9.

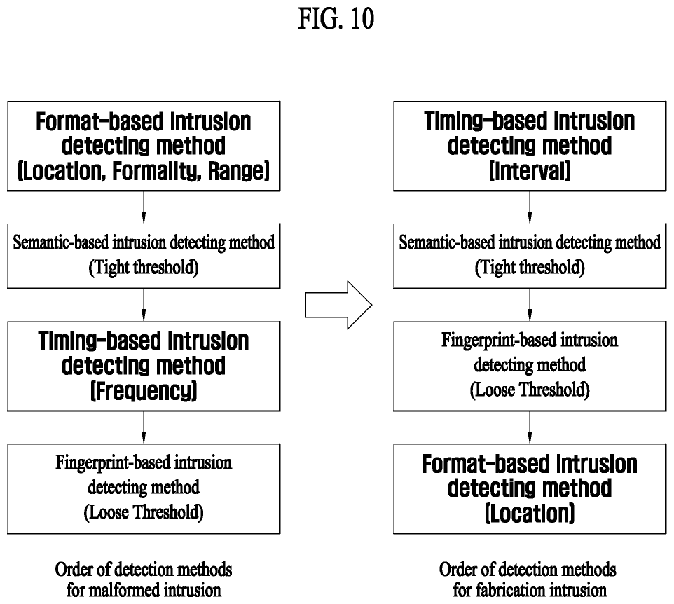

FIG. 10 illustrates a detection intensity of an intrusion detecting method changed based on a priority of the intrusion detecting method according to an example embodiment.

The vehicle 810 may receive, from the electronic apparatus 800, information on a malformed intrusion as a type of an intrusion highly probable to occur in a network of the vehicle 810. The vehicle 810 may recognize priorities of intrusion detecting methods for detecting the malformed intrusion in an order of a format-based intrusion detecting method, a semantic-based intrusion detecting method, a timing-based intrusion detecting method, and a fingerprint-based intrusion detecting method. Since the format-based intrusion detecting method has a high priority, the vehicle 810 may set a high detection intensity for the format-based intrusion detecting method. Specifically, the vehicle 810 may perform the format-based intrusion detecting method using a location, a formality, and a range of a message as features. Since the timing-based intrusion detecting method has a relatively low priority, the vehicle 810 may set a low detection intensity for the timing-based intrusion detecting method. Specifically, the vehicle 810 may perform the timing-based intrusion detecting method by identifying a generation frequency of a message generated in the network of the vehicle 810 for a predetermined period of time. Since the semantic-based intrusion detecting method has a relatively high priority, the vehicle 810 may perform the semantic-based intrusion detecting method based on a tight threshold. Since the fingerprint-based intrusion detecting method has a low priority, the vehicle 810 may perform the fingerprint-based intrusion detecting method based on a loose threshold.

The vehicle 810 may receive, from the electronic apparatus 800, information on a fabrication intrusion as a type of an intrusion highly probable to occur in a network of the vehicle 810. The vehicle 810 may change priorities of intrusion detecting methods from the order of the intrusion detecting methods for detecting the malformed intrusion to an order of intrusion detecting methods for detecting the fabrication intrusion, that is, an order of the timing-based intrusion detecting method, the semantic-based intrusion detecting method, the fingerprint-based intrusion detecting method, and the format-based intrusion detecting method. Since the priority of the timing-based intrusion detecting method increases, the vehicle 810 may set a higher detection intensity for the timing-based intrusion detecting method. Specifically, the vehicle 810 may perform the timing-based intrusion detecting method by identifying generation times of all the messages generated in the network of the vehicle 810. Since the priority of the format-based intrusion detecting method decreases, the vehicle 810 may set a lower detection intensity for the format-based intrusion detecting method. Specifically, the vehicle 810 may perform the format-based intrusion detecting method using a location of a message as a feature.

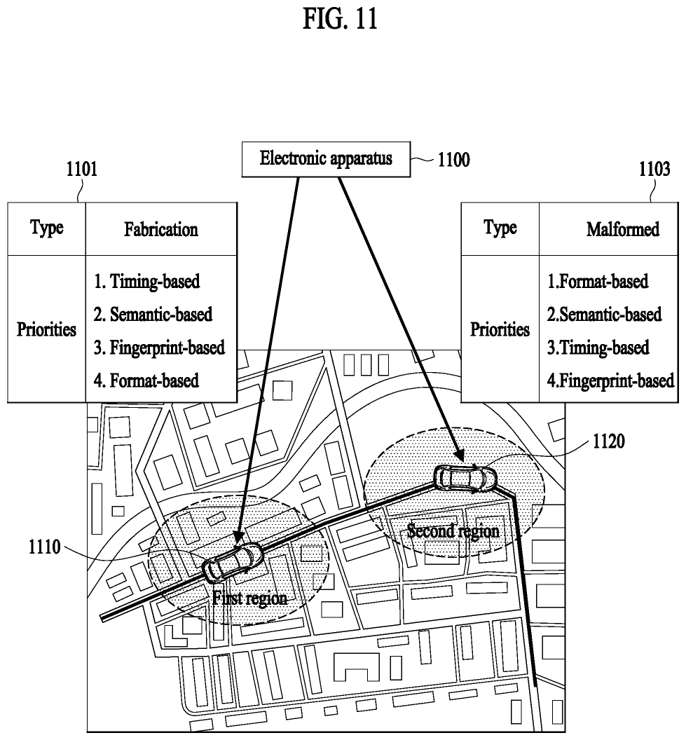

FIG. 11 illustrates an electronic apparatus determining a type of an intrusion to occur in a network of a vehicle according to an example embodiment.

An electronic apparatus 1100 may receive information on types of intrusions detected in vehicles located within a predetermined region from the vehicles and recognize a type of an intrusion that frequently occurs in the predetermined region. Specifically, the electronic apparatus 1100 may receive information on types of intrusions detected in vehicles located in a first region from the vehicles and recognize a fabrication attack intrusion as a type of an intrusion that most frequently occurs in the first region. Likewise, the electronic apparatus 1100 may receive information on types of intrusions detected in vehicles located in a second region from the vehicles and recognize a malformed attack intrusion as a type of an intrusion that most frequently occurs in the second region.

The electronic apparatus 1100 may receive information on a vehicle 1110 from the vehicle 1110. For example, the electronic apparatus 1100 may receive information on a position of the vehicle 1110 and recognize that the vehicle 1110 is located in the first region. The electronic apparatus 1100 may determine the fabrication attack intrusion to be a type of an intrusion to occur in a network of the vehicle 1110. In other words, the electronic apparatus 1100 may determine the fabrication attack intrusion which corresponds to a type of an intrusion most frequently occurring in the first region, to be a type of an intrusion that is highly probable to occur in the network of the vehicle 1110.

The electronic apparatus 1100 may transmit information 1101 on the determined type of the intrusion to the vehicle 1110. The information 1101 may include information on priorities of a plurality of intrusion detecting methods suitable for detecting the fabrication attack intrusion. For example, the vehicle 1110 may set a timing-based intrusion detecting method as a first priority to detect the fabrication attack intrusion which is highly probable to occur in the network of the vehicle 1110.

The electronic apparatus 1100 may receive information on a vehicle 1120 from the vehicle 1120. For example, the electronic apparatus 1100 may receive information on a position of the vehicle 1120 and recognize that the vehicle 1120 is located in the second region. The electronic apparatus 1100 may determine the malformed attack intrusion to be a type of an intrusion to occur in a network of the vehicle 1120. In other words, the electronic apparatus 1100 may determine the malformed attack intrusion which corresponds to a type of an intrusion most frequently occurring in the second region, to be a type of an intrusion that is highly probable to occur in the network of the vehicle 1120.

The electronic apparatus 1100 may transmit information 1103 on the determined type of the intrusion to the vehicle 1120. The information 1103 may include information on priorities of a plurality of intrusion detecting methods suitable for detecting the malformed attack intrusion. For example, the vehicle 1120 may set a format-based intrusion detecting method as a first priority to detect the malformed attack intrusion which is highly probable to occur in the network of the vehicle 1120.

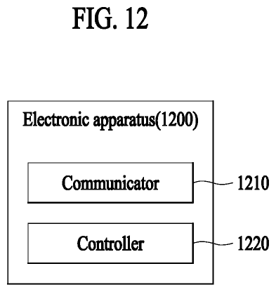

FIG. 12 is a block diagram illustrating an electronic apparatus.

An electronic apparatus 1200 may include a communicator 1210 and a controller 1220. FIG. 12 illustrates only components of the electronic apparatus 1200 related to the present embodiment. However, it will be understood by those skilled in the art that other general-purpose components may be further included in addition to the components illustrated in FIG. 12.

The electronic apparatus 1200 may be a server. For example, the electronic apparatus 1200 may be an SOC.

The communicator 1210 may communicate with a vehicle. The communicator 1210 may use communications technology such as Global System for Mobile communication (GSM), Code Division Multi Access (CDMA), Long Term Evolution (LTE), 5G, Wireless LAN (WLAN), Wireless-Fidelity (Wi-Fi), Bluetooth™ Radio Frequency Identification (RFID), Infrared Data Association (IrDA), ZigBee, and Near Field Communication (NFC), for example.

The communicator 1210 may communicate with the vehicle based on vehicle to infrastructure (V2I) communication or vehicle to network (V2N) communication.

The controller 1220 may control an overall operation of the electronic apparatus 1200 and process data and a signal. The controller 1220 may include at least one hardware unit. In addition, the controller 1220 may be operated by at least one software module generated by executing program codes stored in a memory.

The controller 1220 may receive information on a vehicle through the communicator 1210.

The controller 1220 may determine a type of an intrusion to occur in a network of the vehicle based on the information on the vehicle. In one example, the controller 1220 may determine a type of an intrusion to occur in the network of the vehicle based on information on a type of the vehicle. In another example, the controller 1220 may determine a type of an intrusion to occur in the network of the vehicle based on information on an ECU mounted in the vehicle. In another example, the controller 1220 may determine a type of an intrusion to occur in the network of the vehicle based on information on a position of the vehicle. Specifically, the controller 1220 may receive information on types of intrusions detected in vehicles located within a predetermined region, from the vehicles and determine a type of an intrusion that frequently occurs in the predetermined region. When a position of the vehicle is in the predetermined region, the controller 1220 may determine the type of the intrusion that frequency occurs in the predetermined region, to be a type of an intrusion to occur in the network of the vehicle. In another example, the controller 1220 may determine a type of an intrusion recently detected in the vehicle, to be a type of an intrusion to occur in the network of the vehicle based on information on a vehicle intrusion history.

The controller 1220 may determine an intrusion detecting method suitable for detecting an intrusion having the determined type. The controller 1220 may select an intrusion detecting method suitable for detecting an intrusion having the determined type, from a plurality of intrusion detecting methods. The controller 1220 may determine priorities of a plurality of intrusion detecting methods suitable for detecting an intrusion having the determined type.

The controller 1220 may transmit information on the determined type of the intrusion to the vehicle through the communicator 1210.

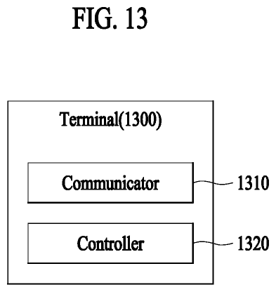

FIG. 13 is a block diagram illustrating a terminal of a vehicle.

A terminal 1300 may be a device disposed in a vehicle to assist driving of the vehicle. The terminal 1300 may include a communicator 1310 and a controller 1320. FIG. 13 illustrates only components of the terminal 1300 related to the present embodiment. However, it will be understood by those skilled in the art that other general-purpose components may be further included in addition to the components illustrated in FIG. 13.

The communicator 1310 may communicate with an external electronic apparatus. The external electronic apparatus may be, for example, a nearby vehicle, a server, or an infrastructure such as an RSU. The communicator 1310 may communicate with an external vehicle or a server based on V2V communication or V2N communication.

The communicator 1310 may use communications technology such as Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, and Near Field Communication (NFC), for example.

The controller 1320 may control an overall operation of the terminal 1300 and process data and a signal. The controller 1320 may include at least one hardware unit. In addition, the controller 1320 may be operated by at least one software module generated by executing program codes stored in a memory.

The controller 1320 may transmit information on a vehicle to an external device through the communicator 1310 and receive information on a type of an intrusion to occur in a network of the vehicle from the external device through the communicator 1310. The controller 1320 may determine whether an intrusion occurs in the network of the vehicle using an intrusion detecting method suitable for detecting an intrusion having a predetermined type based on the information received from the external device.

In one example, the controller 1320 may determine an intrusion detecting method suitable for detecting an intrusion having a predetermined type and detect an intrusion occurring in the network of the vehicle using the determined intrusion detecting method. Also, the controller 1320 may determine priorities of a plurality of intrusion detecting methods suitable for detecting an intrusion having a predetermined type, and detect an intrusion occurring in the network of the vehicle by sequentially using the plurality of intrusion detecting methods based on the determined priorities. In another example, the controller 1320 may detect an intrusion occurring in the network of the vehicle using an intrusion detecting method determined by an external device. Also, the controller 1320 may detect an intrusion occurring in the network of the vehicle by sequentially using a plurality of intrusion detecting methods based on priorities determined by the external device.

The controller 1320 may differently set a detection intensity of an intrusion detecting method based on a priority of the intrusion detecting method. When a priority of the intrusion detecting method is relatively high, the controller 1320 may set a high detection intensity for the intrusion detecting method. When a priority of the intrusion detecting method is relatively low, the controller 1320 may set a low detection intensity for the intrusion detecting method.

The controller 1320 may generate a model for a fingerprint-based intrusion detecting method by collecting voltage data for each ECU mounted in the vehicle. Also, the controller 1320 may train a model that represents a unique voltage characteristic of an ECU through a machine learning based on a message generated in each ECU mounted in the vehicle. When a predetermined event occurs, the controller 1320 may update the model for the fingerprint-based intrusion detecting method by recollecting a message generated in each ECU mounted in the vehicle. For example, when an ECU mounted in the vehicle is replaced, when a fingerprint-based intrusion detecting performance is degraded, or when a vehicle-mounted voltage device is aged, the controller 1320 may update the model for the fingerprint-based intrusion detecting method by recollecting voltage data of the ECU mounted in the vehicle.

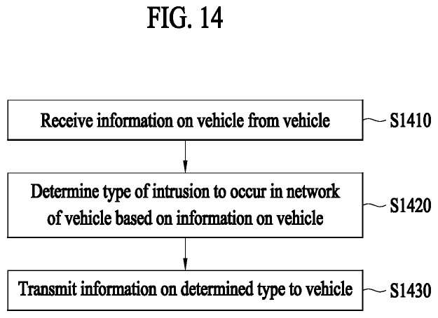

FIG. 14 is a flowchart illustrating an operation method of an electronic apparatus.

In operation S1410, the electronic apparatus 1200 may receive information on a vehicle from the vehicle.

In operation S1420, the electronic apparatus 1200 may determine a type of an intrusion to occur in a network of the vehicle based on the information on the vehicle.

In operation S1430, the electronic apparatus 1200 may transmit information on the type determined in operation S1420 to the vehicle.

According to example embodiments, it is possible to implement an intrusion detecting method with increased efficiency since an electronic apparatus predicts a type of an intrusion highly probable to occur in a network of a vehicle and the vehicle employs an intrusion detecting method suitable for detecting an intrusion having the predicted type. In addition, instead of using all of a plurality of intrusion detecting methods in parallel, the vehicle may sequentially use the plurality of intrusion detecting methods based on priorities to detect an intrusion having the predicted type, which may increase an efficiency of implementing the intrusion detecting method. Also, the vehicle may differently set a detection intensity for an intrusion detecting method based on a priority of the intrusion detecting method, thereby implementing a more efficient intrusion detecting method.

Effects are not limited to the aforementioned effects, and other effects not mentioned will be clearly understood by those skilled in the art from the description of the claims.

The devices of the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The above-described embodiments are merely examples and other embodiments may be implemented within the scope of the following claims.

What is claimed is:

1. An operation method of an electronic apparatus, the method comprising:
receiving information on a vehicle from the vehicle;
determining a type of an intrusion to occur in a network of the vehicle based on the information on the vehicle; and
transmitting information on the determined type to the vehicle.

2. The operation method of claim 1, further comprising:
determining an intrusion detecting method suitable for detecting an intrusion having the determined type; and
transmitting, to the vehicle, information on the determined intrusion detecting method and the determined type.

3. The operation method of claim 2, wherein the determining of the intrusion detecting method comprises determining priorities of a plurality of intrusion detecting methods suitable for detecting an intrusion having the predetermined type, and
the information on the intrusion detecting method includes information on the priorities of the plurality of intrusion detecting methods.

4. The operation method of claim 3, wherein the determining of the priorities of the plurality of intrusion detecting methods comprises:
determining, when the determined type of intrusion is a fabrication attack intrusion, a timing-based intrusion detecting method to be a first priority among the plurality of intrusion detecting methods;
determining, when the determined type of intrusion is a malformed attack intrusion, a format-based intrusion detecting method to be a first priority among the plurality of intrusion detecting methods; and
determining, when the determined type of intrusion is a masquerade attack intrusion, a fingerprint-based intrusion detecting method to be a first priority among the plurality of intrusion detecting methods.

5. The operation method of claim 1, further comprising:
receiving, from vehicles in a first region, information on types of intrusions detected in the vehicles; and
recognizing a type of an intrusion most frequently detected in the first region based on the received information on the types,
wherein when the vehicle is in the first region, the determining comprises determining the recognized type to be a type of an intrusion to occur in the network of the vehicle.

6. The operation method of claim 1, wherein the vehicle determines whether an intrusion occurs in the network of the vehicle using an intrusion detecting method suitable for detecting an intrusion having the determined type.

7. The operation method of claim 6, wherein the vehicle determines an intrusion detecting method suitable for detecting an intrusion having the determined type and determines whether an intrusion occurs in the network of the vehicle using the determined intrusion detecting method.

8. The operation method of claim 1, wherein the vehicle determines whether an intrusion occurs in the network of the vehicle using a plurality of intrusion detecting methods suitable for detecting an intrusion having the determined type and sets a detection intensity of each of the plurality of intrusion detecting methods based on priorities of the plurality of intrusion detecting methods.

9. The operation method of claim 1, wherein the vehicle generates a model for a fingerprint-based intrusion detecting method by collecting voltage data for each electronic control unit (ECU) mounted in the vehicle and updates the model by recollecting voltage data for each ECU mounted in the vehicle when a predetermined event occurs.

10. The operation method of claim 9, wherein the predetermined event includes a replacement of an ECU mounted in the vehicle.

11. The operation method of claim 1, wherein the network of the vehicle is a controller area network (CAN).

12. The operation method of claim 1, wherein the information on the vehicle includes information on at least one of a vehicle identification number (VIN), a type, a position, and a velocity of the vehicle.

13. A non-volatile computer-readable recording medium comprising a computer program for executing the operation method of claim 1.

14. An electronic apparatus comprising:
a communicator; and
a controller configured to receive information on a vehicle from the vehicle through the communicator, determine a type of an intrusion to occur in a network of the vehicle based on the information on the vehicle, and transmit information on the determined type to the vehicle.

15. The electronic apparatus of claim 14, wherein the controller is configured to determine an intrusion detecting method suitable for detecting an intrusion having the determined type and transmit information on the determined intrusion detecting method and the determined type, to the vehicle through the communicator.

16. The electronic apparatus of claim 14, wherein the controller is configured to determine priorities of a plurality of intrusion detecting methods suitable for detecting an intrusion having the predetermined type, and
the information on the intrusion detecting method includes information on the priorities of the plurality of intrusion detecting methods.

17. A terminal of a vehicle, the terminal comprising:
a communicator; and
a controller configured to transmit information on the vehicle to an external device through the communicator, receive information on a type of an intrusion to occur in a network of the vehicle from the external device through the communicator, and determine whether an intrusion occurs in the network of the vehicle using an intrusion detecting method suitable for detecting an intrusion having the type.

18. The terminal of claim 17, wherein the controller is configured to determine an intrusion detecting method suitable for detecting an intrusion having the type and determine whether an intrusion occurs in the network of the vehicle using the determined intrusion detecting method.

19. The terminal of claim 17, wherein the controller is configured to determines whether an intrusion occurs in the network of the vehicle using a plurality of intrusion detecting methods suitable for detecting an intrusion having the type, and set a detection intensity of each of the plurality of intrusion detecting methods based on priorities of the plurality of intrusion detecting methods.

20. The terminal of claim 17, wherein the controller is configured to generate a model for a fingerprint-based intrusion detecting method by collecting voltage data for each electronic control unit (ECU) mounted in the vehicle and update the model by recollecting voltage data for each ECU mounted in the vehicle when a predetermined event occurs.
